(19) United States
(12) Patent Application Publication
(10) Pub. No.: US 2016/0104097 A1
(43) Pub. Date: Apr. 14, 2016

(54) Sales Process Management and Tracking System

(71) Applicant: ZTrack 360, Inc., Dublin, CA (US)

(72) Inventors: Steven E. Larrinaga, Alta Loma, CA (US); Derek A. Perez, Dublin, CA (US)

(73) Assignee: ZTrack 360, Inc., Dublin, CA (US)

(21) Appl. No.: 14/510,682

(22) Filed: Oct. 9, 2014

(51) Int. Cl. G06Q 10/06; G06Q 10/08

(52) U.S. Cl. CPC G06Q 10/063114; G06Q 10/087

(57) ABSTRACT

A system for managing a sales force that includes at least one sales associate comprises a management console and a mobile console that is in communication with the management console via a data communication network. The mobile console includes a positioning module for determining a geographical position of the mobile console, an interface for receiving input from the sales associate, a display for presenting information to the sales associate, a wireless communication interface for sending and receiving information via the data communication network, a data reader, a memory for storing information and operational instructions for the mobile console, and a processor for controlling and for sending information to and receiving information from the positioning module, the interface, the display, the wireless communication interface, the data reader, and the memory.

### FIELD

This invention relates to the field of sales management. More particularly, this invention relates to tracking and managing the activities of a sales force disposed within a defined geographical boundary.

### INTRODUCTION

Having accurate and timely information is often a critically important part of business management. This general principle applies to the management of a sales force, such as a sales force consisting of one or more sales managers and one or more sales associates. Such a sales force can be found in many different settings, such as a retail store, vehicle dealership, or crowd vendors in a sporting venue.

In the past, it has been labor-intensive for the sales manager to know which associates have arrived at the place of business, when they arrived, if they are currently helping a customer, the progress that they are making with the customer, whether they have left the place of business (and for what purpose), and so forth.

What is needed, therefore, is a system that reduces problems such as those described above, at least in part.

### SUMMARY

The above and other needs are met by a system for managing a sales force that includes at least one sales associate. In a preferred embodiment, the system includes a data communication network, a management console in communication with the data communication network, and a mobile console in communication with the data communication network. The mobile console includes a positioning module for determining a geographical position of the mobile console, an interface for receiving input from the associate, a display for presenting information to the associate, a wireless communication interface for sending information to and receiving information from the data communication network, a data reader, a memory for storing the information that is sent and received and also for storing operational instructions for the mobile console, and a processor for controlling and for sending information to and receiving information from the positioning module, the interface, the display, the wireless communication interface, the bar code reader, and the memory.

In various embodiments, the processor or the memory include programming for sending a report to the management console when the mobile console enters a designated geographical boundary. In some embodiments the designated geographical boundary substantially comprises a vehicle dealership. In some embodiments the management console identifies a sequential order in which mobile consoles enter the designated geographical boundary, constructs a queue based on the order, and sends messages to the mobile consoles indicating their ranking in the queue. The process of tracking the location of the mobile console and detecting an event associated with the crossing of a geographic boundary is also referred to as geo-tracking, geo-fencing, geo-mapping, and geo-targeting. Some embodiments employ beacons for these purposes.

In some embodiments the data reader is a bar code reader. In some embodiments the processor or the memory include programming for sending a report to the management console when the mobile console exits a designated geographical boundary. In some embodiments the processor or the memory include programming for sending information read through the data reader to the management console. In some embodiments the processor or the memory include programming to identify information received through the data reader, which information is captured from a driver's license or a vehicle identification number.

In some embodiments the mobile console is smart phone. In some embodiments the data communication network is a wireless data network or a cellular data network. In some embodiments the positioning module is a global positioning system (GPS) module. In some embodiments the interface is a touch-screen, a voice recognition module, or a keyboard.

In another aspect, the invention provides a method for managing a sales force that includes at least one sales associate. A report is sent from an associate's mobile console over a data communication network to a management console when the mobile console enters a designated geographical boundary. A queue position is sent from the management console over the data communication network to the mobile console, where the queue position indicates an order in which the mobile console entered the designated geographical boundary. A customer is assigned to the associate based at least in part on the queue position sent to the associate's mobile console.

In various embodiments according to this aspect of the invention, the mobile console is used to scan information on the customer's vehicle, the customer's driver's license, or a new vehicle in which the customer is interested. The scanned information is sent from the mobile console to the management console over the data communication network. In some embodiments the scan is performed with a bar code reader built into the mobile console. In some embodiments the designated geographical boundary substantially comprises a vehicle dealership. In some embodiments the mobile console is a smart phone. In some embodiments the data communication network is a wireless data network or a cellular data network. In some embodiments GPS is used to determine when the mobile console is within the designated geographical boundary.

According to yet another aspect, the invention provides a method for logging information regarding a test drive of a vehicle by a customer leaving a vehicle dealership. A VIN from a vehicle and information from the customer's driver's license is read with a data reader in a mobile console, and is sent via a wireless communication interface in the mobile console to a management console over a data communication network. A first report is also sent via the wireless communication interface in the mobile console over the data communication network to the management console when a geographical position determination circuit in the mobile console determines that the mobile console has exited the vehicle dealership. Route information of the vehicle is tracked during the test drive using the geographical position determination circuit in the mobile console, which information is sent via the wireless communication interface in the mobile console over the data communication network to the management console. A second report is sent via the wireless communication interface in the mobile console over the data communication network to the management console based on the geographical position determination circuit determining that the mobile console has reentered the vehicle dealership.

### DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is a functional block diagram of a sales force tracking and management system according to an embodiment of the present invention; and

FIG. 2 is a flow chart of a method of operating the sales force tracking and management system according to an embodiment of the present invention.

### DESCRIPTION

With reference now to the figures, there are described various embodiments of the present invention. Although these embodiments are generally applicable to a wide variety of sales environments, the particular example of vehicle sales at a vehicle dealership is used as the primary example below.

### APPARATUS

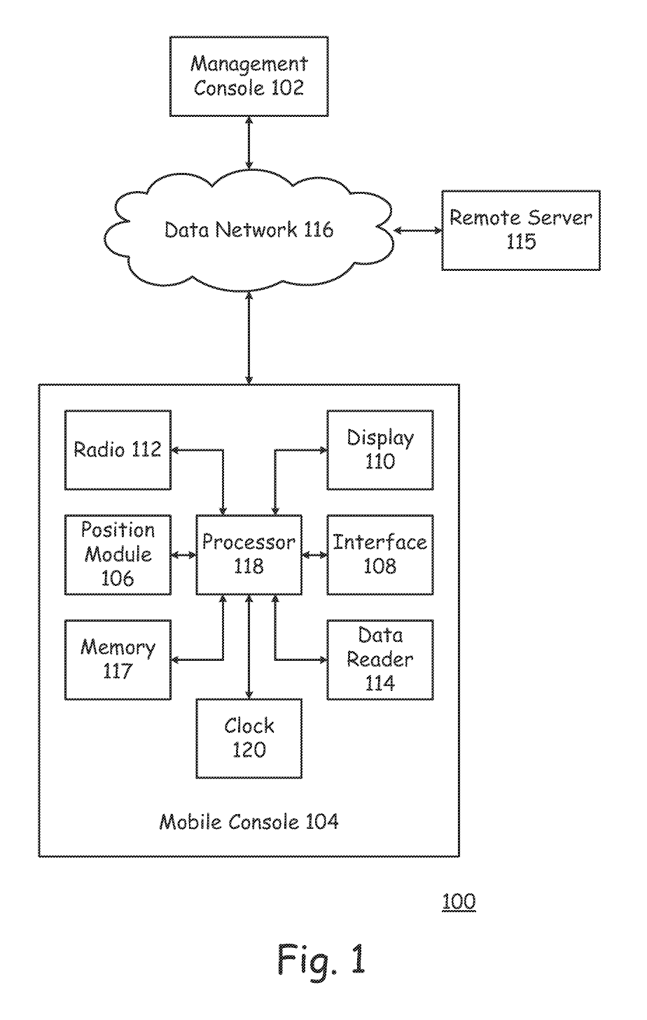

FIG. 1 depicts a functional block diagram of the sales force tracking and management system 100 according to one embodiment of the present invention. In this embodiment, a management console 102 is in communication with a data network 116, which is in communication with a mobile console 104. The management console 102 can take a variety of different forms, but in one embodiment is a computing platform such as a personal computer or laptop computer. In other embodiments, the management console 102 is a mobile computing platform, such as a smart phone or a tablet computer.

In some embodiments the mobile console 104 is a mobile computing platform, such as a smart phone or a tablet computer. In other embodiments, the mobile console 104 is a dedicated hardware device that is built specifically for the functions and purposes described herein, and having the hardware components as described herein. In some embodiments the mobile console 104 is a smart watch. In some embodiments, the mobile console 104 is a laptop computer or a desktop personal computer.

The data network 116 is, in some embodiments, a global network such as the Internet. In other embodiments, the data network 116 is a private local network. Other data networks are also contemplated. In some embodiments, the data network 116 includes a wireless network, such as a cellular data network. In some embodiments, the data network 116 is combination of networks, such as an IEEE 802.3 Ethernet network connected to the Internet, a cellular network such as IEEE 802.16, or a local wireless network such as an IEEE 802.11 a/b/g/n network, for example.

In some embodiments of the invention, some or all of the processing tasks described herein are performed on a cloud-based remote server 115 that is in communication with the management console 102 and the mobile console 104 via the data network 116. In these embodiments, the management console 102 and the mobile console 104 pass data back and forth to the remote server using dedicated software applications loaded on the management console 102 and mobile console 104 or via web browser applications on the management console 102 and mobile console 104.

The management console 102, data network 116, and mobile console 104 are configured to have the capability for the management console 102 and the mobile console 104 to send messages and other data back and forth one to another. Some of these messages and data are automatically sent and received, in that they are initiated by the sending device upon the occurrence of one or more predetermined events and received by the receiving device without the user thereof making a request for any such information. Others of these messages and data are manually sent and received, in that at least one of the users of the sending and receiving devices makes a request for such information to either be sent or received, as described in more detail below.

In some embodiments, the mobile console 104 includes the hardware modules as depicted in FIG. 1 and generally described below. A wireless communication interface 112 is used to wirelessly communicate with the data network 116. In this regard, the term “wireless communication interface” is used in a generic sense, and not by way of limitation, to indicate a circuit that generally converts a data signal received on a wire into a broadcast signal, such as a terrestrial broadcast signal, and vice versa. In various embodiments, the wireless communication interface 112 is capable of communicating with one or more of the data networks 116 as described above.

A display 110 presents information to the user of the mobile console 104, such as the messages that are sent and received, and other information and data. In some embodiments the display 110 is a graphics-based color display, such as an LED/LCD screen or an AMOLED display. A user interface 108 accepts input from the user of the mobile console 104, such as manually entered messages and control instructions for the mobile console 104. In some embodiments the interface 108 is a keyboard, and in some embodiments the interface 108 is a touchscreen comprising a touch-sensitive or proximity-sensitive layer integrated into the display 110.

In some embodiments the mobile console 104 includes a data reader 114, which is an alternate means for inputting data to the mobile console 104. For example, in some embodiments that data reader 114 is a laser bar code scanner. In other embodiments, the data reader 114 is a sensor such as a camera that can capture either still images or video. In some embodiments the data reader 114 works in conjunction with a processor 118 to convert information that is captured in a visual format into electronic data, such as by using optical character recognition (OCR) to convert graphically captured text characters into ASCII characters (or some other digital data standard) or converting optically captured bar codes into one or more digital data standards. In some embodiments that data reader 114 includes capabilities such as facial recognition and biometric input. In some embodiments, the data reader 114 is an RFID tag reader.

Some embodiments of the present invention include a position module 106. In some embodiments the position module 106 is a GPS module. In other embodiments the position module 106 detects some other type of terrestrial based signal, such as a cellular signal, and uses information in conjunction with that signal to determine the geographical position of the mobile console 104, such as by one or more of signal strength, triangulation, or some other method.

A memory 117 provides storage for messages and data that is either captured by, input to, or received by one or more of the wireless communication interface 112, the user interface 108, and the data reader 114 of the mobile console 104. In some embodiments the memory 117 also provides storage for command and programming information that is used by the processor 118 to control the operation of the mobile console 104.

Some embodiments of the mobile console 104 also include a clock 120. In some embodiments the clock 120 includes the capability to receive a time signal, such as through the wireless communication interface 112, so the clock 120 can be accurately maintained, either automatically or upon the input of a command by the user of the mobile console 104 to update the clock 120. In some embodiments the clock 120 contains circuitry to maintain the time when an external time confirmation source is not available.

The management console 102, data network 116, and mobile console 104 work in conjunction one with another to implement the functions and general operation of the sales management system as described herein.

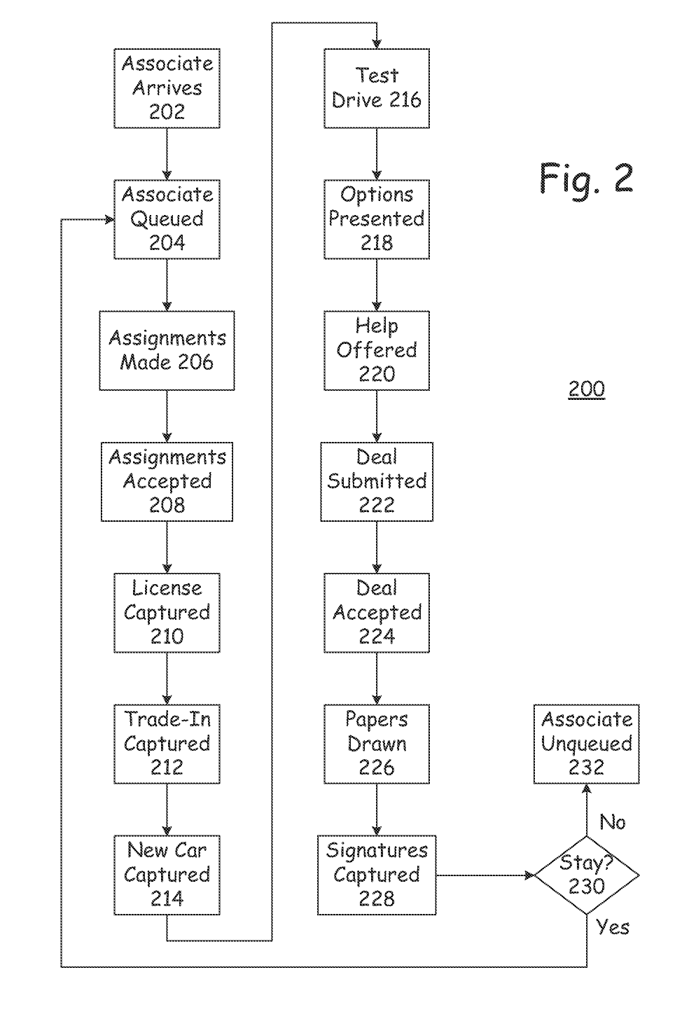

With reference now to FIG. 2, there is depicted a simplified flow-chart 200 for the operation of a preferred embodiment of the sales force tracking and management system 100. It is appreciated that the order of these steps in all embodiments is not necessarily the same as that as given in the embodiment depicted in FIG. 2. In this embodiment, the system 100 is activated when sales associates arrive at the sales venue, carrying their mobile consoles 104 (step 202). The position module 106 reports the position of the mobile console 104, and thereby the position of the associate, as the associate enters the sales venue, such as a vehicle dealership. One or more of the management console 102 and the mobile console 106 checks the position of the mobile console 104 relative to a predefined geographical boundary, such as the boundaries of the vehicle dealership (to continue the present example), and a report is thereby made from the mobile console 104 to the management console 102 that the associate has arrived at the sales venue. In some embodiments a time stamp, such as from the clock 120, is associated with the report that is generated.

In one embodiment, the management console 102 builds a queue of the associates who have arrived at the sales venue (step 204). In some embodiments, those associates who arrive earliest, such as based on the time stamp described above, are given higher priority in the queue that is built, and they are the associates assigned to the first customers that arrive (step 206). Thus, the sales system 100 keeps track of the associates in this manner, and is aware of which associates are available to help customers.

When an associate is up in the queue to receive a customer, the management console 102 pushes a notification to that associate's mobile console 104. In one embodiment, this is an automated message from the management console 102 to the mobile console 104, in that the system 100 identifies that the associate is on the sales lot, identifies a customer waiting for service, identifies the next associate in the queue, and pushes out the assignment message to the appropriate mobile console 106 without any other intervention by either the sales associate or the sales manager.

In one embodiment, the associate manually sends a message from the mobile console 104 to the management console 102 indicating that the associate has received the assignment and accepted it (step 208). While this can be accomplished in a number of different ways, in one embodiment the associate merely presses an acknowledgement button that appears on the display 110 of the mobile console 104 when the assignment message is received, and the simple press of the button (either a software button or a hardware button, for example) is sufficient to send the acceptance message back to the management console 102.

In the embodiment in which the system 100 is used for the management of a vehicle dealership, there is a variety of information that is typically gathered from the customer. For example, if the customer is interested in a test drive of a new vehicle, then the customer might need a valid driver's license. In one embodiment, the associate uses the data reader 114 on the mobile console 104 to read the bar code on the customer's driver's license, thereby capturing the relevant data therefrom, and the mobile console 104 transmits the information to the management console 102, where the information is kept on file as needed (step 210). In some embodiments, the data reader 114 optically scans the text-based information on the driver's license, recognizes the text, and sends that information to the management console 102. In some embodiments, the data reader 114 captures an image of the driver's license and sends the image to the management console 102 for any further processing as desired. In some embodiments, the information from the driver's license is compared to a database of such information that is accessible by the management console 102, to determine whether there are any issues involved with allowing the customer to take a test drive.

In some embodiments, if the customer desires to trade in their current vehicle, the associate uses the data reader 114 on the mobile console 104 to read the VIN of the vehicle that is to be traded in (step 212). The VIN information can be captured in a variety of different ways, such as those described above. In some embodiments the mobile console 104 captures the VIN information and provides a form for the associate to fill out to capture the other information about the vehicle that is needed to determine a trade in value, such as the mileage, general condition, outstanding balance, and so forth.

The relevant information is transferred from the mobile console 104 to the management console 102, which acts as an interface to a database of used vehicle value information, such as KBB.com or Edmunds.com. The value of the trade in can then be automatically pushed out to the mobile console 104 from which the initial information was received, so that the associate can report to the customer the value of the trade in.

In some embodiments, the data reader 114 is also used to capture the VIN of the “new” vehicle that the customer is interested in buying (which is new to the customer, but may be a used vehicle) (step 214), and this information is transmitted by the mobile console 104 to the management console 102. This information can be used in a variety of different ways. For example, it can be used in a log of when the new vehicle is taken for test drives. It can also be used to identify potential conflicts, such as when more than one customer is interested in the same new vehicle. It can also be used to help put together a package offer to the customer, with a price that reflects the value of the new vehicle and the value of the customer's trade in.

In some embodiments that mobile console 104 has a button on the interface 108 or display 110 that the associate can push, indicating that the associate and the customer are going on a test drive. In one embodiment, this invokes the positioning module 106, and the route and duration of the test drive are logged by one or both of the management console 102 and the mobile console 104. If the information from the VIN of the new vehicle was recorded (step 214) and the driver's license information was recorded (step 210), then a complete record of the details of the test drive can be assembled and logged.

At some point during the sales presentation, such as after the test drive in some embodiments, the mobile console 104 can be used to present a variety of sales options to the customer (step 218). For example, the customer can be shown a comparison of the prices of the various cars of interest, with or without the value of the trade in included. In addition, cost of ownership can be included in the comparison, taking into account factors such as gas mileage, anticipated maintenance, insurance, and other relevant factors.

In some embodiments, if a deal is not submitted within a predetermined length of time, or upon the occurrence of some other event, then a push (automatic) notification of an offer to help with the sale is sent from the management console 102 to the mobile console 104 (step 220), such as by presenting an image of a button on the display 110 of the mobile console 104. In some embodiments, a secondary notification is also provided, such as by making a sound or causing the mobile console 104 to vibrate. If the sales associate would like assistance from the sales manager or another associate, then the associate can confirm this by merely pressing the button that is presented on the mobile console 104 which generates a confirmation message transmitted from the mobile console 104. Upon receipt of such a confirmation message, the management console 102 can notify another party, such as either the sales manager or another associate, to go the assistance of the sales associate, and can even provide the geographical location of the sales associate, in some embodiments.

The sales associate can use the mobile console 104 to submit a deal proposal through the management console to the sales manager (step 222). In response, the sales manager can send a message to the associate as to whether the deal is acceptable (step 224). If the deal is not accepted, then the sales manager can provide a counter offer through the management console 102 to the associate with the mobile console 104.

When the deal is acceptable to all parties, the management console 102 can produce the necessary documentation of the deal (step 226). In some embodiments the documentation is reduced to paper, while in other embodiments the relevant signatures can be captured on one or more of the management console 102 and the mobile console 104 (step 228). In a similar manner, the management console 102 or the mobile console 104 can be used, in some embodiments, to receive payment information, such as that required for a bank draft, or to apply for financing, process title, license, and registration paperwork, and so forth. Much of this can be accomplished by using the information that has already been gathered by the mobile console 104 during the initial sales process.

When the sale is concluded, the associate can indicate whether he/she is available for another customer (step 230). If the associate can take another customer, then the associate is returned to the queue (step 204) and the sales process is repeated. If the associate is no longer available, then the associate is removed from the queue (step 232).

In some embodiments, the mobile console 104 tracks when the sales associate leaves the predetermined geographical area of the sales venue, such as using one of the ways as described above, and sends a message of such to the management console 102. In some embodiments, this action of leaving the sales venue automatically takes the associate out of the queue. Also in the manner as indicated above, a time stamp can be associated with this information.

In some embodiments, the management console 102 presents a status display that provides a clear view of the current live activity at the sales venue, such as which associates are on the premises and their locations, which associates are with customers and at what point in the sales process they are, cars that are potential trade ins, cars that are being considered for purchase, route and duration of test drives, customer information, associate performance toward goals, and so forth.

In some embodiments, the mobile console 104 presents a status display that provides information to the associate, such as the length of time with the current customer, value of the trade in, acceptable base offer for the new vehicle, additional information in regard to the customer (such as found from a database), future appointments, messages from the sales manager, performance toward goals, and so forth.

In some embodiments the management console 102 keeps track of customers who have not made a purchase, and sends follow up sales and notice communications to such customers, such as via email or postal mail.

In some embodiments, the management console 102 pushes notifications to the mobile consoles 104 regarding cars on the sales lot that the sales manager has a heightened desire to sell. In this manner, the associates can be sure to show those cars to the customers. In some embodiments, the mobile console 104 presents a notification button on the display 110 of the mobile console 104 that the associate can press, sending a message to the management console 102 confirming that the associate has shown a given priority vehicle to his current customer.

In some embodiments, the management console 102 stores information regarding cars that a first customer has expressed an interest in, and indicates to the sales manager when a second customer arrives with a similar vehicle for potential trade in.

The foregoing description of embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. A system for managing a sales force that includes at least one sales associate, the system comprising:
a data communication network;
a management console in communication with the data communication network; and
one or more mobile consoles in communication with the data communication network, the one or more mobile consoles comprising:
a positioning module for determining a geographical position of the mobile console;
a user interface for receiving input from the sales associate;
a display for presenting information to the sales associate;
a wireless communication interface for sending information to and receiving information from the data communication network;
a data reader;
a memory for storing the information that is sent and received and for storing operational instructions for the mobile console; and
a processor for controlling and for sending information to and receiving information from the positioning module, the user interface, the display, the wireless communication interface, the data reader, and the memory.

2. The system of claim 1, wherein at least one of the processor and memory further comprise programming for sending a report to the management console based on one or more of the mobile consoles crossing a designated geographical boundary.

3. The system of claim 2, wherein the designated geographical boundary surrounds a vehicle dealership.

4. The system of claim 2, wherein the management console identifies an order in which multiple mobile consoles enter the designated geographical boundary, constructs a queue based on the order, and sends messages to the mobile consoles indicating their ranking in the queue.

5. The system of claim 1, wherein the data reader is a bar code reader or a camera.

6. The system of claim 1, wherein at least one of the processor and memory further comprise programming for sending a report to the management console when the mobile console exits a designated geographical boundary.

7. The system of claim 1, wherein at least one of the processor and memory further comprise programming for sending information read through the data reader to the management console.

8. The system of claim 1, wherein at least one of the processor and memory include programming to identify information received through the data reader, where the information is captured from at least one of a driver's license and a vehicle identification number.

9. The system of claim 1, wherein the mobile console is a smart phone or a tablet computer.

10. The system of claim 1, wherein the data communication network is at least one of a wireless data network and a cellular data network.

11. The system of claim 1, wherein the positioning module is a global positioning system module.

12. The system of claim 1, wherein the user interface is at least one of a touch-screen, a voice recognition module, and a keyboard.

13. A method for managing a sales force, including at least one sales associate, the method comprising the steps of:
sending a report from a sales associate's mobile console over a data communication network to a management console based on the mobile console entering a designated geographical boundary;
sending a queue position from the management console over the data communication network to the mobile console, where the queue position indicates an order in which the mobile console entered the designated geographical boundary compared to other mobile consoles that entered the designated geographical boundary; and
assigning a customer to the sales associate based at least in part on the queue position sent to the sales associate's mobile console.

14. The method of claim 13, further comprising using the mobile console to scan information on at least one of a customer's vehicle, a customer's driver's license, and a new vehicle that a customer is interested in, and sending the information from the mobile console to the management console over the data communication network.

15. The method of claim 14, wherein the scan is performed with a bar code reader or a camera built into the mobile console.

16. The method of claim 13, wherein the designated geographical boundary surrounds a vehicle dealership.

17. The method of claim 13, wherein the mobile console is smart phone or a tablet computer.

18. The method of claim 13, wherein the data communication network is at least one of a wireless data network and a cellular data network.

19. The method of claim 13, wherein a global positioning system is used to determine when the mobile console is within the designated geographical boundary.

20. A method for logging information regarding a test drive of a vehicle by a customer leaving a vehicle dealership, the method comprising the steps of:
reading a vehicle identification number from the vehicle with a data reader in a mobile console;
reading information from the customer's driver's license with the data reader in the mobile console;
sending the vehicle identification number and the information from the customer's driver's license from a wireless communication interface in the mobile console to a management console via a data communication network;
sending a first report from the wireless communication interface in the mobile console via the data communication network to the management console based on a geographical position determination circuit in the mobile console determining that the mobile console has exited the vehicle dealership;
acquiring route information of the vehicle during the test drive using the geographical position determination circuit in the mobile console;
sending the route information from the wireless communication interface in the mobile console via the data communication network to the management console; and
sending a second report from the wireless communication interface in the mobile console via the data communication network to the management console based the geographical position determination circuit determining that the mobile console has reentered the vehicle dealership.
